(19) United States
(12) Patent Application Publication
(10) Pub. No.: US 2003/0103884 A1
(43) Pub. Date: Jun. 5, 2003

(54) Low-emission method of recovering sulfur from sour industrial gases

(75) Inventor: Scott Lynn, Pleasant Hill, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Regents of the University of California, Berkeley, CA

(21) Appl. No.: 10/011,166

(22) Filed: Nov. 30, 2001

(51) Int. Cl. C01B 17/05

(52) U.S. Cl. 423/220; 423/574.1

(57) ABSTRACT

The present invention provides a process for purifying a sour gas stream containing H₂S, which process comprises:

(a) absorbing H₂S from the sour gas by contacting the gas with an H₂S absorbent in an absorber to obtain an H₂S-rich absorbent;

(b) stripping H₂S from the H₂S-rich absorbent to obtain an H₂S-rich gas;

(c) feeding the H₂S-rich gas together with an SO₂-rich gas, so that the H₂S is in stoichiometric excess, into a reactor column in the presence of a solvent and catalyst that catalyzes their reaction to form liquid sulfur and water vapor;

(d) recovering the liquid sulfur from the reactor column;

(e) recovering an H₂S-rich off-gas from the reactor column; and

(f) recovering H₂S from the H₂S-rich off-gas and recycling the H₂S thus recovered to the reactor of step (c).

Preferably, the absorber column used in step (f) is part of the same absorber column that is used for step (a). Alternatively, the absorber of step (f) may be a second absorber, different from that of step (a), in which case a second H₂S-rich gas is recovered from the second absorber, and is fed to the reactor, preferably as a combined stream with the H₂S-rich gas from step (b).

Preferably, the H₂S-rich off-gas from the reactor column is cooled, dewatered and compressed while being recycled to the H₂S absorber.

### BACKGROUND OF THE INVENTION

### FIELD OF THE INVENTION

The present invention relates to a process of removing hydrogen sulfide from natural gas or other industrial gas, in an integrated system wherein sulfur is produced. More preferably, the present invention relates to such processes wherein small quantities of sulfur are produced.

One of the most common systems for processing natural gas containing hydrogen sulfide and producing sulfur involves the use of well-known absorber-stripper steps to separate H₂S and the well-known Claus process to produce sulfur. In such system, in simplified form, the basic steps are usually:

(a) H₂S removal from sour gas, using an H₂S absorbent, to obtain sweetened product natural gas.

(b) Stripping H₂S out of the H₂S-rich absorbent to obtain H₂S.

(c) H₂S combustion to obtain SO₂ and H₂S.

(d) Solid-catalyzed H₂S reaction with SO₂ at high temperature to form and recover S and to make an off-gas containing reduced amounts of H₂S and SO₂.

(e) Treating the off-gas from step (d) to recover as S a major fraction of the remaining amounts of H₂S and SO₂ and to form a stack gas that is released to the atmosphere.

Steps (c) and (d) in combination are often regarded as the Claus process.

A system that is directed to treating sour gas but does not include reaction of H₂S to form sulfur is shown in FIG. 14-24 of Kohl and Riesenfeld, Gulf Publishing Co., 1979 “Gas Purification”, 3rd Edition. FIG. 14-24 in the Kohl et al. reference shows the basic steps of (a) H₂S removal from sour gas using an absorbent to take out the H₂S, so as to obtain treated (sweetened gas) of reduced H₂S content out the top of the absorber or “contactor” and H₂S-rich absorbent out of the bottom of the absorber; and (b) stripping H₂S out of the H₂S-rich absorbent, by a flash regeneration technique and a heated regeneration technique to strip H₂S from the absorbent and obtain H₂S and regenerated (lean) absorbent for reuse in step (a).

The system illustrated in the Kohl et al. reference uses a physical absorbent, such as propylene carbonate.

A chemical solvent could be used in that basic system, possibly without the flash regeneration part of step (b). Examples of known chemical-type absorbents include amines, such as monoethanolamine (“MEA”).

Just as the Kohl et al. reference at FIG. 14-24 is directed to H₂S absorption/stripping steps, also FIG. 4 from the paper “Claus Revisited: The UC Sulfur Recovery Process”, 1997 GRI Sulfur Recovery Conference, Austin, Tex., Oct. 12-15, 1997, by Scott Lynn, shows the resultant H₂S from absorption/stripping being routed to a reactor where it flows concurrently with a solution of SO₂ in a system that replaces both a Claus plant and the off-gas treatment step (see the flow configuration illustrated in FIG. 3) and is directed toward large tonnage production rates for sulfur.

A challenging gas-sweetening problem arises when a sour industrial gas stream that contains hydrogen sulfide (H₂S) must be treated if the quantity of sulfur to be recovered is only about 0.1-10 tonnes per day (1 tonne=1000 kg). In such processes the sour gas stream has a low concentration of H₂S, generally from as little as 100 parts per million to as much as 1-2 vol. %. Aqueous redox processes, in which a chelated metal ion (such as Fe⁺³) serves as an oxidizing agent, can be used for this sweetening step. The sour gas is contacted directly with the solution and the H₂S is oxidized to form solid elemental sulfur in the contacting device (usually a column). The colloidal sulfur slurry exiting the column must be filtered to separate the sulfur, the sulfur must be washed free of mother liquor, and then the solution must be regenerated by aeration. Such processes are characterized by a tendency to plug, have several operating steps, have high chemical operating costs, and produce an impure sulfur that has little (or negative) commercial value. They also produce an aqueous discharge that must be treated before being released to the environment. Recent experience with one such process, trade named LO-CAT, was described by Nagl, G. J., “The State of Liquid Redox”, presented at the 9th Gas Research Institute Sulfur Recovery Conference in San Antonio, Tex., Oct. 24-27, 1999; and a similar report for the SULFEROX process was presented by Smit, C. J. and Heyman, E. C., “Present Status Sulferox Process”, at the 9th Gas Research Institute Sulfur Recovery Conference in San Antonio, Tex., Oct. 24-27, 1999.

A second approach is taken in the CRYSTASULF process described by McIntosh, K. E., C. O. Reuter, K. E. DeBerry, Jr. and D. W. DeBerry, “H₂S Removal and Sulfur Recovery Options for High-Pressure Natural Gas with Medium Amounts of Sulfur”, presented at the Sulfur 2000 International Conference and Exhibition in San Francisco, Calif., Oct. 29-Nov. 1, 2000. A high-pressure gas containing a low concentration of H₂S is contacted with a solution of SO₂ sequestered in an organic solvent at a temperature high enough to keep the sulfur formed in solution. The rich solvent is flashed to an intermediate pressure, and the flash gas may or may not be recompressed and returned to the contacting column. The rich solvent is then flashed again into a crystallizer where the liquid is cooled to crystallize and precipitate the sulfur, which is separated and washed in a centrifuge. The lean solvent from this step is mixed with SO₂ and returned to the contactor. The CRYSTASULF process is operated at a temperature that is high enough to prevent crystallization of the sulfur formed, and the solvent as it enters is saturated with water. A significant energy input is required to heat the gas to the treatment temperature and additional effort is required to remove the water that evaporates from the solvent into the gas. The crystallization operation involves several steps with expensive equipment. Solvent degradation leads to a significant chemical cost and the formation of sulfate and other salts as byproducts requires their removal from the solvent and subsequent disposal. The quality of the solid sulfur produced is intermediate between that from aqueous redox processes and that from a typical Claus plant.

Both the redox-type process and the CRYSTASULF-type process described above have certain desirable attributes, but such processes are characterized by a tendency to plug, have a relatively large number of operating steps, have high chemical operating costs, and, in addition, the former produces an impure sulfur that has little (or negative) commercial value. They also produce an aqueous discharge that must be treated before being released to the environment.

The process described below is comparatively simple in both design and operation, can produce a substantially pure liquid sulfur from the H₂S, has very low or substantially no gaseous emissions and has comparatively low chemical and operating costs.

### SUMMARY OF THE INVENTION

According to the present invention, a process is provided for purifying a sour gas stream containing H₂S, which process comprises:

(a) absorbing H₂S from the sour gas by contacting the gas with an H₂S absorbent in an absorber to obtain an H₂S-rich absorbent and a sweetened gas;

(b) stripping H₂S from the H₂S-rich absorbent to obtain an H₂S-rich gas and a lean absorbent;

(c) reacting the H₂S-rich gas with SO₂, the H₂S being in stoichiometric excess, in a reactor in the presence of a solvent and optionally a catalyst, to form liquid sulfur and water vapor;

(d) recovering the liquid sulfur from the reactor;

(e) recovering an H₂S-rich off-gas from the reactor; and

(f) recovering H₂S from the H₂S-rich off-gas and recycling the H₂S thus recovered to the reactor of step (c).

According to one preferred embodiment of the present invention, step (f) comprises compressing the H₂S-rich off-gas from step (e) and adding it, at an appropriate point, to the absorber of step (a). That is, the H₂S-rich off-gas from step (e) is recycled to the absorber used in the first step. The combined H₂S values are fed to the reactor of step (c). In another preferred embodiment of the invention, the H₂S-rich off-gas from step (e) is introduced into a second absorber (different from the first absorber) to produce a purified gas and a second H₂S-rich absorbent. H₂S may then be stripped from the second H₂S-rich absorbent and the stripped gas is added to and combined with the H₂S-rich gas from step (b) and fed with it to the reaction with SO₂ [step (c) above)] or, preferably, the H₂S-rich absorbent from step (f) may be combined with that from step (a) so that the H₂S obtained in step (b) represents the combined H₂S values to be fed to the reactor of step (c).

In another preferred embodiment of the invention, the overall process does not involve a combustion step to produce SO₂, thus offering an opportunity to eliminate the capital cost of a combustion furnace and associated equipment.

It is especially preferred to apply the process of the present invention to relatively small-scale sulfur recovery operations, preferably in the range of about 0.1 to 20 tonnes of sulfur recovery per day. More broadly, the range may be 0.01 to 100 tonnes per day of sulfur, but more preferably smaller ranges, such as 0.1 to 10 tonnes per day of sulfur.

The off-gas from the reactor column may contain as little as 1 mol % H₂S, but preferably contains 10 mol % or higher H₂S.

Among other factors, the present invention is based on the concept and finding that use of the combined steps set forth above, particularly including the use of a reactor receiving feed H₂S from an absorber-stripper series of steps, and the use of a recycle loop for H₂S from the reactor, achieves a surprising cost-effectiveness, simplicity and reliability of operation for producing high purity industrial gas from sour gas while simultaneously producing high quality product sulfur.

### DETAILED DESCRIPTION OF THE INVENTION

In a sulfur recovery process of the type described in my prior patent application WO 99/12849, gaseous hydrogen sulfide (H₂S) reacts with gaseous sulfur dioxide (SO₂) in the presence of an organic liquid wherein the following reaction occurs:

2H₂S(g)+SO₂(g)→3S(l)+2H₂O(g) (1)

The source of the H₂S for the present invention, shown in both drawings, is a conventional absorber/stripper operation that removes H₂S from a sour industrial gas. The types of sour industrial gases to which this invention may be applied include, but are not limited to, sulfur-containing natural gas, recycle gas from enhanced oil-recovery operations using CO₂ flooding, and methane recovered from biological treatment of garbage and other wastes. Depending on the source, the sour gas may be available at pressures as low as ambient or as high as 1.5 Mpa absolute (200 psig) or even higher. Depending on the use to which it is to be put, the sweetened gas produced by the process of this invention may be delivered at a pressure up to 7 Mpa absolute (1000 psig) or even higher. The sour gas may be sweetened first, then compressed, or it may be compressed first, then sweetened. The decision depends upon a number of factors, including the cost of the absorber, the type of absorbent to be used, the nature of the major gas components and various economic considerations, and is a matter of economic optimization. Typically, the preferred operating pressure range for the H₂S absorber is between 430 kPa and 10 MPa absolute (50 and 1500 psig), more preferably between 1.5 and 7 Mpa (200 and 1000 psig).

The H₂S-rich absorbent from the absorber is fed to a stripper to strip out the H₂S feedstream to the reactor. The absorbent used in the absorber and recovered in the stripper is one typically used in such equipment, for instance a physical absorbent such as propylene carbonate or a chemical absorbent such as MEA (monoethanolamine) or MDEA (methyldiethanolamine). In the stripper the H₂S-rich absorbent is contacted countercurrently with a rising stream of a hot gas that typically consists primarily of water vapor and a small amount of absorbent vapor, and an H₂S-rich gas is recovered as overhead. The preferred operating pressure range for the stripper is between 130 and 430 kPa absolute (5 and 50 psig), more preferably between 160 and 430 kPa absolute (10 and 50 psig).

The H₂S-rich gas recovered from the absorber/stripper operation is then reacted with SO₂ in a solvent to produce sulfur, preferably in the presence of a catalyst for reaction (1). Preferably the SO₂ also enters the reactor in gaseous form. The H₂S-rich gas fed to the reactor (which is preferably in the form of a column) may contain as little as 10 mol % H₂S, but preferably contains 50 mol % or higher H₂S and may contain substantially pure H₂S. The SO₂-rich gas may contain as little as 20 mol % SO₂ (dry basis) but preferably contains 90 mol % or higher SO₂.

The SO₂ can be provided, as is often done in such installations, by combustion of H₂S in a furnace. For example, H₂S recovered from the overhead of the reactor, perhaps together with H₂S from other process sources, is combusted to produce the SO₂ for use in reaction (1). An alternative source of SO₂ is the combustion of a part of the elemental sulfur produced in the process of this invention. However, in accordance with a preferred embodiment of this invention, the process does not include combustion of H₂S and the SO₂ is obtained from another source, for example by purchase or by production in another process or installation at the same or another manufacturing site. Especially in a smaller scale operation, such as one that is designed to produce only from about 0.1-10 tonnes per day of sulfur, the additional cost of purchasing SO₂ should be more than offset by the elimination of capital and operating costs associated with construction and running of a small-scale combustion furnace and associated equipment such as a waste heat boiler, and of an SO₂ absorption system for recovering SO₂ from the combustion gases. In general, the source of the SO₂ for the reactor of this process will typically be a tank of the anhydrous liquid compound, although alternative sources will be apparent to those skilled in the art.

The organic liquid or solvent used in the reaction, also of the type described in WO 99/12849, which patent application is incorporated herein by reference, is preferably miscible with water, has a low volatility, is a relatively good solvent for both reactants, catalyzes Reaction (1), and is one in which liquid sulfur has a limited but low solubility.

Preferred solvents for the reactor column include polyethyleneglycol ethers, such as the methyl ether of triethylene glycol, the dimethyl ether of triethylene glycol, and the dimethyl ether of polyethylene glycol. The methyl ether of diethyleneglycol is particularly preferred for use in the reactor column in the process of the present invention. The solvent used in the reactor column may also be a catalyst for the reaction of H₂S with SO₂ to form sulfur. However, according to a preferred embodiment of the present invention, a catalyst is added to the solvent to catalyze or enhance catalysis of the reaction of H₂S with SO₂ to form sulfur. Preferred catalysts are those described in PCT application WO 99/12849. Preferred catalysts are tertiary amines (including mixtures of tertiary amines), including those in which alkyl and/or aryl groups are substituted on the nitrogen atom and those in which the nitrogen atom is contained within an aromatic-type ring. Examples of suitable tertiary amine catalysts in which the nitrogen atom is not included within a ring are trialkylamines such as triethylamine, tri-n-butylamine and mixed trialkylamines, and mixed alkyl/aryl tertiary amines such as N,N-diemethylaniline.

The preferred catalysts for this reaction are tertiary amines that contain an aromatic ring nitrogen atom that is not sterically hindered by substitutions at carbon atoms adjacent the ring nitrogen, i.e. N-substituted aromatic-ring compounds in which there is no moiety attached to a carbon adjacent to a ring nitrogen. Preferred catalysts include substituted and unsubstituted pyridines, quinolines, and isoquinolines, such as pyridine, isoquinoline or 3-methyl pyridine, optionally substituted at one or more sites not adjacent the ring nitrogen atom. The compound 3-hydroxymethyl pyridine (3-pyridyl carbinol) is a particularly preferred catalyst for use in the reactor column in the present invention.

The reactor used in the process of the present invention preferably is a reactor column. The term “column” is used to denote that the reactor vessel is a column substantially similar to the type used in fractional distillation. Fractional distillation is a well-known art, and the basic form of a distillation column is well known: elongated vessels with trays or packing or even “bales” of material. The trays can be weep-hole trays or bubble-cap trays. In the reactor column of the present invention, liquid solvent preferably flows downward and the gases containing H₂S and SO₂ either flow downward (co-currently with the liquid) or flow upward (counter-currently to the liquid). In a column employing co-current flow only packing will be used whereas in a column employing counter-current flow either packing or trays may be used.

The choice of flow configuration will depend on the scale of the operation, the kinetics of the reaction in the solvent chosen, the specifications for the sulfur product and other factors that are familiar to those skilled in the art. However, the principles of the invention are the same in both flow configurations as will be clear from the description that follows.

In the reactor column, it is desired to operate above the melting point of sulfur. The sulfur produced by Reaction (1) forms a separate liquid phase that flows co-currently with the organic liquid. Preferred operating temperatures for the reactor column in the process of the present invention are 120° to 155° C., more preferably 120° to 145° C., and still more preferably 125° to 140° C.

The walls of the reactor and of the piping through which liquid flows are preferably heated to maintain a temperature in the range 120°-150° C., preferably between 125°-140° C., to maintain sulfur formed in the reaction substantially in the liquid (molten) form and substantially to prevent deposit of solid sulfur. The temperature inside the reactor preferably is also maintained in the range 120°-150° C., more preferably 125°-140° C. The inside temperature of the reactor is preferably maintained by: a) feeding a sufficiently large flow of cooled inlet solvent, b) by adding water to the inlet solvent that vaporizes as the wet solvent flows through the reactor, c) by injecting water at various points in the reactor or by all three of the foregoing. The evaporation of water from the solvent may absorb most of the heat of the reaction; the energy released by Reaction (1) is about 3.4 times the molar heat of vaporization of H₂O. Preferably, a heat exchanger is used in the solvent pump-around line to remove part of the heat of reaction during operation, as well as to heat the system prior to startup. The reactor preferably operates at a pressure nominally equal to that of the H₂S stripper, of the order of 1.5 to 3 atmospheres absolute, but is not limited to that range. The higher the pressure, the more rapid will be the reaction between the two gases.

Reaction (1) occurs only in the liquid phase, and at temperatures up to 150° C. there is no equilibrium limitation (in contrast to the gas-phase reaction employed above the dewpoint of sulfur in the conventional Claus process). Since both the H₂S and SO₂ preferably enter the reactor column as gases, the function of the reactor-column internals, i.e., the packing or trays, is to enhance mass transfer between the gas and the liquid. Column-type reactors are employed in the process of this invention in preference to other designs, such as stirred tanks, primarily for economic reasons.

As portions of the H₂S and SO₂ dissolve in the organic solvent they react to form sulfur. The stoichiometric excess of H₂S relative to SO₂ fed to the reactor column is at least 1%, preferably 10%, and is more preferably 15% or higher. The H₂S-rich off-gas exiting the reactor column contains a relatively small amount of unreacted SO₂ together with any co-absorbed components from the original sour gas that are inert in the reaction.

In a further preferred embodiment, the H₂S-rich off-gas is scrubbed with an aqueous stream after it is separated from the solvent in the reactor column to recover solvent vapor and unreacted SO₂ and then is cooled to obtain condensate water prior to step (f). The aqueous scrubbing liquor from this step is preferably mixed with the solvent stream, either prior to or within the reactor column, so that its evaporation can serve to remove a part of the heat of the reaction. In the process of the present invention, the aqueous stream used to scrub the H₂S-rich gas in the upper section of the reactor column is preferably a part of the condensate formed when the H₂S-rich off-gas is cooled.

As mentioned above, the invention includes the use of a recycle loop for the H₂S-rich off-gas from the reactor column, resulting in recovery of the H₂S values of this gas and recycle to the reactor. As described in detail below, this may be accomplished in at least two different ways. One important part of this feature of the invention is the enhancement of operation of the reactor column with regard to reducing the SO₂ content of the reactorcolumn overhead, as this feature makes practicable the use of a substantial stoichiometric excess of H₂S relative to SO₂ in the reactor column. Another important part of this feature is the recovery of hydrocarbon gases that are less soluble in the solvent than H₂S, but that may also be co-dissolved in the H₂S-rich solvent from the H₂S absorber. In a preferred embodiment, these co-dissolved hydrocarbon gases, such as propane, and to a lesser extent ethane and methane, can be recovered together with the excess H₂S via the recycle loop and recombined with the sour feed gas to the initial absorber in the process of the present invention. In another preferred embodiment, these hydrocarbon gases can be recovered as relatively low-pressure fuel gas after having been sweetened in a separate absorber, with the excess H₂S being recycled to the reactor.

The term “H₂S-rich off-gas” is used herein to refer not only to the gas exiting the reactor column, but also is used to follow that gas stream through the off-gas-treatment system and back to the H₂S absorber as a recycle loop stream, or, in an alternate embodiment, to a second H₂S absorber, from where the H₂S is recovered and recycled to the reactor.

The first-mentioned embodiment, compressing and recycling the H₂S-rich off-gas to the sour gas absorber, enables operation of the process using a single absorber. However, on the other hand, compression of that gas to the pressure of the sour-gas absorber is necessary in that embodiment. The second embodiment, use of a second absorber, avoids the need for compression of the H₂S-rich gas, but requires a second absorber. The choice among the embodiments will depend on the economics and convenience at the particular installation involved.

In the first-mentioned embodiment of the present invention, in which the H₂S-rich gas is to be compressed, the off-gas-treatment system preferably will include one, and more preferably will include all three, of the following steps, although these steps are not regarded as essential to the invention: 1) A scrubbing step in which solvent vapor and unreacted SO₂ are absorbed from the H₂S-rich off-gas by countercurrent contact with an aqueous stream. H₂S and SO₂ react very rapidly in water to form colloidal sulfur. The scrubbing liquor leaving the scrubbing step may either be mixed with the solvent stream that is pumped back to the entrance of the reactor column or it may be injected at various points along the reactor column. In either case the scrubbing liquor serves as a coolant by evaporating as the solvent stream flows down the reactor column. When this expedient is used, the H₂S-rich off-gas leaving the scrubbing step is substantially free of SO₂. 2) A cooling step, in which the H₂S-rich off-gas is cooled to generate condensate. Preferably, a part of the condensate is used as the scrubbing liquor fed to step 1 and the remainder flows through a stripper to remove dissolved H₂S and becomes a product of the process. 3) A compression step, preferably included for the off-gas-treatment system in the present invention, compresses the cooled H₂S-rich off-gas prior to introducing the H₂S-rich off-gas to an H₂S absorber. More preferably, the compression step compresses the H₂S-rich off-gas to the pressure of the sour industrial gas that is to be sweetened and the H₂S-rich off-gas is fed to the bottom of the absorber that removes H₂S from that sour industrial gas.

In accordance with the-above-described embodiment of the present invention, the H₂S-rich off-gas from the reactor column is compressed to the nominal pressure of the sour industrial gas as it enters the H₂S absorber. This enables recycle of the H₂S-rich off-gas from the reactor column into the H₂S absorber. Preferred operating pressure range for the reactor column is between 130 and 430 kPa absolute (5 and 50 psig), more preferably between 160 and 430 kPa absolute (10 and 50 psig). Consideration of the work required to compress the H₂S-rich off-gas from the reactor column will be a consideration in determining the pressure at which to operate the H₂S absorber.

As mentioned above, in another preferred embodiment, these hydrocarbon gases can be recovered as relatively low-pressure fuel gas after having been sweetened in a separate absorber, with the excess H₂S being recycled to the reactor. In this embodiment, compression of the gas is not required.

Referring again to the reaction of SO₂ with H₂S in the countercurrent reactor column (see FIG. 2), at least part of the SO₂ preferably enters the column a tray or two below the entry of the H₂S-containing stream so that the liquid sulfur and the solvent are stripped of H₂S before they leave the column. For both types of reactor column, the two liquids are preferably separated by decantation at the exit; the organic liquid is recycled to the top of the column whereas the liquid sulfur forms a product of the process.

In the process of the present invention substantially all of the SO₂ is preferably reacted within the reactor, consuming a large fraction, preferably 50% to 90% or more, of the entering H₂S. After being cooled and partially dried as noted above, the unreacted H₂S together with any co-absorbed components from the original sour gas that are inert in the reaction is compressed and fed along with the original sour industrial gas stream to an appropriate point or points near the bottom of the absorption column mentioned above or conveyed to a second absorber, as described above, from which it is recovered and mixed with the H₂S-rich gas from the first absorber, and is fed to the reactor. In this way, the unreacted H₂S can be re-absorbed and returned to the reactor column whereas any co-absorbed but unreactive components of the original sour industrial gas are recombined with it so that there is substantially no net loss of such gases in the sulfur-recovery process.

In the practice of this invention, it is usually preferable to minimize the quantity of gas returned to the reactor, especially if the gas is to be compressed. It is thus preferable, but not essential, to use substantially pure SO₂, as is characteristic of commercially available liquid SO₂, as feed to the reactor column since it would generally be undesirable to introduce excessive quantities of impurities such as nitrogen into the original industrial gas stream. Similarly, the fraction of the H₂S that reacts in passing through the column is preferably maximized. However, the larger the fraction of the H₂S that reacts in passing through the column, the larger the residence time that must be provided for the gas flowing through the reactor column. Accordingly, in the process of the present invention, there will be an optimal combination of reactor-column size and H₂S-rich off-gas recycle.

Combining the steps set forth above, particularly including use of a reactor column receiving feed H₂S from an absorber-stripper series of steps and use of a recycle loop for H₂S-rich off-gas from the reactor column, achieves surprising cost effectiveness, simplicity and reliability of operation for producing high purity industrial gas from sour gas while simultaneously producing high-quality product sulfur.

The reactor column does not use an aqueous redox step with attendant additional operation steps and high chemical costs, nor does the operation of the absorber column require heating the sour-gas feed as in a CRYSTASULF-type process, nor does the absorber operate at an elevated temperature that would evaporate substantial amounts of water from the absorber solvent into the sweet gas.

### BRIEF DESCRIPTION OF THE DRAWINGS

FIGS. 1 and 2 are schematic process flow diagrams that illustrate embodiments of the present invention in simplified form. In FIG. 1 the reactor is a column that employs co-current flow of the gases, solvent and liquid sulfur. In FIG. 2 the gases flow countercurrent to the liquids in a column.

FIGS. 1 and 2 are simplified process-flow diagrams that show the major components of the process of the invention. FIG. 1 illustrates the use of a reactor column employing co-current flow of the gases and liquids, with both streams flowing down, whereas FIG. 2 illustrates the use of a reactor column employing counter-current flow of the gases and liquids, with the liquid streams flowing down and the gases flowing up. The co-current column necessarily employs a packing to promote intimate mixing between the liquids and gases as they flow. The counter-current column can employ either a packing or trays such as are used in distillation columns. Except for the columns the two process-flow diagrams are identical, and the common features will be described only once in the material that follows. To facilitate the description, items of equipment are given numbers that are within circles whereas streams are given numbers that are within squares. A given stream maintains the same number as it flows through pumps and heat exchangers as long as its composition is unchanged.

FIG. 1

To facilitate the description that follows, items of equipment are given three-digit numbers whereas streams are given one- or two-digit numbers. A given stream retains the same number as it flows through pumps and heat exchangers, so long as its composition is unchanged.

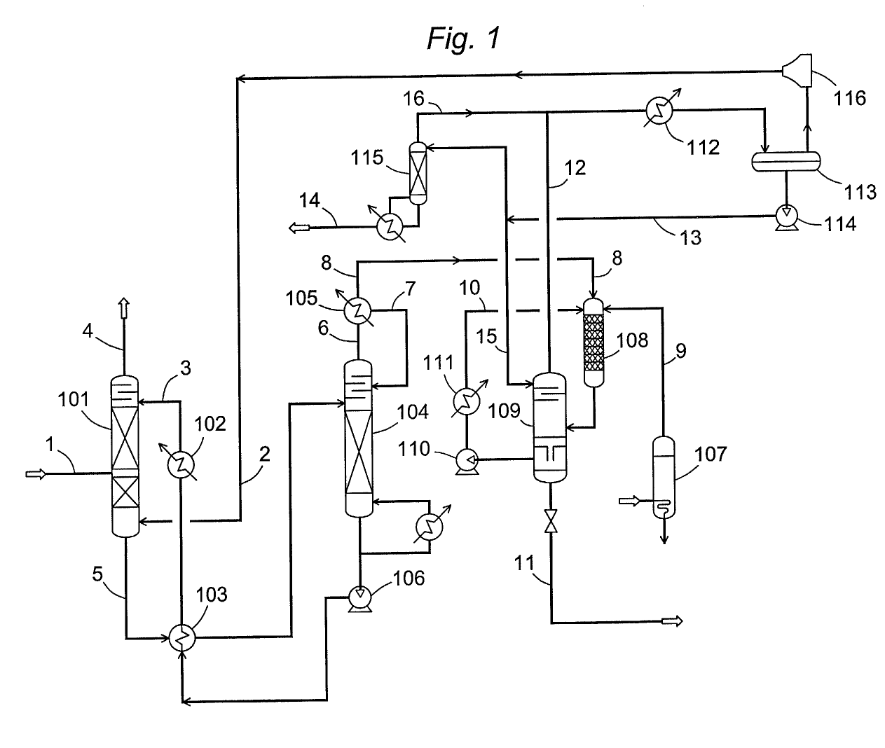

In FIG. 1 a stream of sour industrial gas, 1, enters Absorber 101 at an intermediate point near the bottom. Recycled H₂S-rich gas, 2, which will have a higher concentration of H₂S, enters at a lower point. Cooled lean absorbent, 3, from Heat Exchanger 102 enters Absorber 101 at the top and the sweet gas, 4, leaves Absorber 101 at the top after preferably having flowed through a demisting section to separate entrained droplets.

H₂S-rich absorbent, 5, leaves Absorber 101 and flows through Heat Exchanger 103 where it is heated by lean absorbent, stream 3. It then enters Stripper 104 where it is contacted by a stream of hot vapor that strips dissolved H₂S from it as it descends through the stripper. The stream, 6, of hot, wet H₂S leaving Stripper 104 is cooled in Condenser 105 and the condensate, 7, is returned to Stripper 104 as reflux. Hot, lean absorbent, 3, is pumped by Pump 106 through Heat Exchanger 103, where it is cooled first by the H₂S-rich absorbent, 5, and then by cooling water in Heat Exchanger 102.

The simplest method for supplying SO₂ to the process is to vaporize the required flow from Liquid SO₂ tank 107, as shown. Steam, as shown, electricity or some other heat source may be used. Alternatively, the SO₂ may be supplied by burning product sulfur with air, O₂-enriched air or pure O₂. A combustion process would require the installation of a furnace, a waste-heat boiler and, in most cases, an air compressor. If air were used, two moles of nitrogen would be introduced into the sweet gas for each mole of H₂S removed. However, the cost of the liquid SO₂ would be saved. As discussed above, especially in a smaller scale operation such as one that is designed to produce only from about 0.1-10 tonnes per day of sulfur, the additional cost of purchasing SO₂ should be more than offset by the elimination of capital and operating costs associated with construction and running of a combustion furnace and associated equipment such as a waste heat boiler, and of an SO₂ absorption system for recovering SO₂ from the combustion gases. In general, the source of the SO₂ for the reactor of this process will typically be a tank of the anhydrous liquid compound, although alternative sources will be apparent to those skilled in the art.

The reactor (108) shown in this FIG. 1 is in the form of a column. The SO₂-rich stream fed to Reactor Column 108 is stream 9. The H₂S-rich stream fed to Reactor Column 108 is stream 8. The solvent stream fed to Reactor Column 108 is stream 10. These streams flow co-currently at relatively high velocity over the packing after entering the top of Reactor Column 108 and the two reactants are absorbed by and react in the solvent phase to form water vapor and a second liquid phase of elemental sulfur. In addition, dissolved water vaporizes from the solvent so that the desired range of temperatures is maintained. The combined streams flow directly into Gas/Liquid/Liquid Separator (G/L/L) 109, which may be close-coupled to Reactor Column 108. Liquid sulfur settles rapidly to the bottom of G/L/L 109 and is decanted as one of the products of the process, stream 11. Gas stream 12 is scrubbed with aqueous stream 15 to remove solvent vapor, react away residual SO₂ and provide coolant as noted above. H₂S and SO₂ react very rapidly in water to form colloidal sulfur and when the scrubbing liquor is mixed with the solvent stream in G/L/L 109, with which it is fully miscible, this colloidal sulfur melts and joins the product sulfur, stream 11. The solvent, stream 10, from G/L/L 109 is pumped by Pump 110 through Heat Exchanger 111, where it is cooled or heated as necessary, and flows back to the inlet of Reactor Column 108.

The hot, wet H₂S-rich recycle gas, stream 12, is combined with stream 16, the off-gas from Sour-Water Stripper 115, and flows to Condenser 112 and then to Gas/Liquid Separator 113. The condensate, stream 13, contains a small amount of H₂S and is pumped by Pump 114 and is split into the scrubbing liquor, stream 15, entering G/L/L 109, and the aqueous stream that becomes stream 14, the product water from the process, after passing through Sour-Water Stripper 115. The cooled H₂S-rich recycle gas, stream 2, from Gas/Liquid Separator 113, flows to Compressor 116, where its pressure is increased to substantially that of the sour industrial gas, and from there to the bottom of Absorber 101.

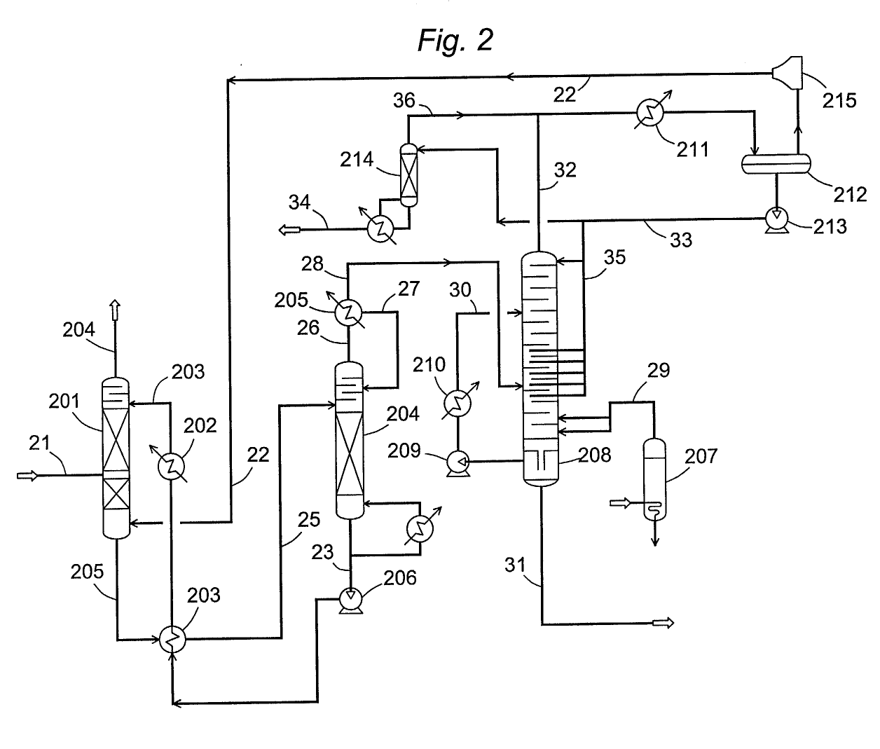

FIG. 2

In FIG. 2 the solvent and gas streams entering Reactor Column 208 arise as they did in FIG. 1. However, Reactor Column 208 employs counter-current flow of the gases and liquids and may use a packing but more preferably will use trays. The solvent, stream 20, preferably enters near the top of the column, below the aqueous-scrubbing section. As the solvent descends through the column it absorbs H₂S and SO₂ from the rising gas stream; the liquid-phase reaction between the two forms water vapor and a separate, co-currently flowing phase of liquid sulfur. The heat of reaction may be absorbed by a) feeding a sufficiently large flow of cooled inlet solvent, b) by adding water to the inlet solvent that vaporizes as the wet solvent flows through the reactor column or c) by injecting water at various points in the column but preferably is absorbed by a combination of at least two of the foregoing. The H₂S-rich gas, stream 28, preferably enters one or two trays above the bottom of the column. Preferably at least a part of the SO₂-rich gas, stream 29, enters at or near the bottom of the column and serves the function of stripping dissolved H₂S from the liquid sulfur product. Preferably the liquid sulfur product is decanted from the solvent stream and leaves Reactor Column 208 in stream 31. Decanted solvent, stream 30, is pumped from the bottom of Reactor Column 208 by Pump 209 through Heat Exchanger 210, where it is cooled or heated as necessary, and flows back to the inlet of Reactor Column 208. Preferably a part of aqueous stream 35 is used to scrub the H₂S-rich off gas leaving the solvent-flow section of Reactor Column 208 to remove solvent vapor, react away residual SO₂ and provide coolant as noted above. H₂S and SO₂ react very rapidly in water to form colloidal sulfur and when the scrubbing liquor is mixed with the solvent stream, with which it preferably is fully miscible, in the section immediately below the scrubbing section, this colloidal sulfur melts and joins the sulfur phase. Another part of aqueous stream 35 is preferably injected into the solvent flowing over the lower trays of Reactor Column 208 to allow more nearly isothermal operation of the column. The scrubbed, hot, wet off-gas, stream 32, leaves Reactor Column 208 and is treated as described in the discussion of FIG. 1.

Comparison of Co-current and Counter-current Columns

The gas velocity in a column with co-current flow of gas and liquid can be significantly higher than in a column with counter-current flow of the same streams. As a result, the column diameter will be smaller and the cost of the column will be relatively less for co-current flow. Offsetting this advantage is the need for a gas/liquid/liquid separator into which the phases flow; the diameter of this device is essentially the same as the diameter of the counter-current flow. It is generally the case that packing is somewhat less expensive than are trays for a column of a given height. While trays are not an option for a column with co-current flow they are an alternative when counter-current flow is employed. An important additional factor, however, is the relative importance of the kinetics of the chemical reaction. With a very fast reaction the rate of reaction is controlled by gas-phase diffusion and the use of a co-current packed column would likely be the more economical choice. As the reaction becomes slower it becomes necessary to increase liquid-phase residence time and the use of trays in a column employing counter-current flow is indicated. Reaction kinetics depends upon both solvent and the catalyst employed as well as the temperature of operation, so all of these factors will enter into the choice of reactor configuration.

### EXAMPLE

A natural gas stream at ambient temperature and a pressure of 6.9 Mpa (1000 psia) is flowing at a rate of 650 kmol/hr and contains 1 mol % H₂S or 5 tonnes of sulfur per day. The system used to treat this gas is the configuration shown in FIG. 2. The sour gas is sweetened in an absorber employing a physical solvent, the methyl ether of diethylene glycol. The flow of solvent through the absorber is 12,000 kg/hr. The flow of H₂S-rich recycle gas to the absorber contains 3.25 kmol/hr of H₂S. The flow of H₂S-rich gas from the stripper contains 9.75 kmol/hr of H₂S and is fed to a tray-type reactor column employing counter-current flow. The flow of SO₂ to the reactor column is 3.25 kmol/hr or 5 tonnes per day and the amount of sulfur produced is 9.75 kmol/hr or 7.5 tonnes per day. The H₂S-rich off-gas from the reactor column contains 3.25 kmol/hr. The flow of solvent circulated around the column is 500 kg/hr and the amount of water used in the scrubbing operation is 5 kmol/hr. The solvent used in the reactor column is also the methyl ether of diethylene glycol.

The reactor column has a diameter of 0.3 m (12 inches) and contains 20 trays in the solvent section and 3 trays in the scrubbing section. The total height of the reactor column is 10 m (33 feet), which includes sufficient volume to contain the solvent inventory for the reactor-column system.

What is claimed is:

1. A process for purifying a sour gas stream containing H₂S, which process comprises:
(a) absorbing H₂S from the sour gas by contacting the gas with an H₂S, absorbent in an absorber to obtain an H₂S-rich absorbent;
(b) stripping H₂S from the H₂S-rich absorbent to obtain an H₂S-rich gas;
(c) reacting the H₂S-rich gas with SO₂, the H₂S gas being in stoichiometric excess, in a reactor in the presence of a solvent and optionally a catalyst, to form liquid sulfur and water vapor;
(d) recovering the liquid sulfur from the reactor;
(e) recovering an H₂S-rich off-gas from the reactor; and
(f) recovering H₂S from the H₂S-rich off-gas and recycling the H₂S thus recovered to the reactor of step (c).

2. A process in accordance with claim 1 wherein the sour gas stream further comprises one or more hydrocarbon gases, at least a part of said hydrocarbon gases being contained in the H₂S-rich off-gas.

3. A process in accordance with claim 1 wherein step (f) comprises absorbing H₂S from the H₂S-rich off-gas by introducing the H₂S-rich off-gas into the absorber of step (a).

4. A process in accordance with claim 1 wherein step (f) is conducted in a second absorber, and further comprising: (g) recovering a second H₂S-rich gas from the absorber of step (f); and (h) feeding the second H₂S-rich gas into the reactor of step (c).

5. A process in accordance with claim 4 wherein the second H₂S-rich gas is combined with the H₂S-rich gas from step (b) and the combined streams are fed into the reactor of step (c).

6. A process in accordance with claim 1 further comprising (j) separating the H₂S-rich off-gas from solvent subsequent to step (c), (k) contacting the H₂S-rich gas from step (j) with an aqueous stream to recover solvent vapor and to react unreacted SO₂ that may be present in the off-gas with H₂S to form sulfur and (m) cooling the H₂S-rich gas from step (k) to produce condensate water.

7. A process in accordance with claim 6 wherein the aqueous stream used to contact the H₂S-rich off-gas in step (k) comprises condensate formed in step (m).

8. A process in accordance with claim 7 wherein the aqueous stream used to contact the H₂S-rich off-gas in step (k) is subsequently mixed with the solvent at selected points within the reactor to remove a portion of the heat of the reaction between the H₂S and the SO₂ by vaporization of the aqueous stream.

9. A process in accordance with claim 1 wherein the gases and liquids flow co-currently through the reactor.

10. A process in accordance with claim 1 wherein the gases flow counter-currently to the liquids through the reactor.

11. A process in accordance with claim 1 wherein the H₂ S-rich off-gas from the reactor is compressed prior to step (f).

12. A process in accordance with claim 1 wherein the SO₂ used in step (c) is obtained by heating liquid SO₂.

13. A process in accordance with claim 1 wherein the solvent used in the reactor comprises a polyethyleneglycol ether or a mixture of polyethyleneglycol ethers.

14. A process in accordance with claim 13 wherein the solvent comprises the methyl ether of diethyleneglycol.

15. A process in accordance with claim 1 wherein the catalyst used in the reactor column is miscible with the solvent and is selected from tertiary amines.

16. A process according to claim 15 wherein the catalyst is selected from N-substituted aromatic-ring compounds in which there is no moiety attached to a carbon adjacent to a ring nitrogen.

17. A process according to claim 16 in which the catalyst is selected from optionally substituted pyridines, quinolines and isoquinolines.

18. A process in accordance with claim 15 wherein the catalyst is 3-hydroxymethyl pyridine.

29. A process in accordance with claim 1 wherein the reactor is a column reactor.
